(19) United States
(12) Patent Application Publication
(10) Pub. No.: US 2003/0042249 A1
(43) Pub. Date: Mar. 6, 2003

(54) Heating sleeve for medical examination instruments

(76) Inventor: Mei-Lin Chen, Taipei City (TW)

Correspondence Address: Mei Lin CHEN, P.O. Box 82-144, Taipei, TW

(21) Appl. No.: 09/941,601

(22) Filed: Aug. 30, 2001

(51) Int. Cl. H05B 3/34

(52) U.S. Cl. 219/535; 219/528; 219/549

(57) ABSTRACT

A heating sleeve for medical examination instruments includes an open circular band having a free end provided with a first engaging means and another free end provided with a second engaging means engageable with the first engaging means, a flexible heat emitting member affixed to an inner side of the open circular band, a power source mounted on an outer side of the open circular band, whereby the power source will heat the flexible heat emitting member thereby rapidly warning a contact member of a medical examination instrument and therefore preventing a patient from feeling uncomfortable to the cold contact member.

### BACKGROUND OF THE INVENTION

1. Field of the Invention

This invention is related to a heating sleeve for medical examination instruments and in particular to one which can warm the medical examination instrument thereby preventing a patient from feeling cold and uncomfortable when contacting the instrument.

2. Description of the Prior Art

The stethoscope is a medical examination instrument used for listening to breathing, heartbeats and other sounds made by the body. However, the patient will feel cold and uncomfortable when the sound receiver of the stethoscope contacts the body and so it has long been hoped to mitigate this drawback. Hence, a heating device for stethoscopes has been developed to meet this need, which generally includes a base, a housing, a heating member and a silicon gel sheet. When in use, the stethoscope must be first placed on the heating device in order to get warm and then removed for listening to breathing, heartbeats and other sounds made by the body of the patient. Hence, the stethoscope will be gradually cooled when it is separated from the heating device. Further, the structure of such a heating device is complicated thus increasing its cost. Moreover, the heating device must be connected with an external power source so that it will become useless when there is no power outlet nearby.

Therefore, it is an object of the present invention to provide an improved heating sleeve for medical examination instruments which can obviate and mitigate the above-mentioned drawbacks.

### SUMMARY OF THE INVENTION

This invention is related to a heating sleeve for medical examination instruments.

It is the primary object of the present invention to provide a heating sleeve for medical examination instruments which can warm the medical examination instrument thereby preventing a patient from feeling cold and uncomfortable when contacting the instrument.

It is another object of the present invention to provide a heating sleeve for medical examination instruments which is not required to be connected with an external power source.

According to preferred embodiment of the present invention, a heating sleeve for medical examination instruments includes an open circular band having a free end provided with a first engaging means and another free end provided with a second engaging means engageable with the first engaging means, a flexible heat emitting member affixed to an inner side of the open circular band, a power source mounted on an outer side of the open circular band, whereby the power source will heat the flexible heat emitting member thereby rapidly warning a contact member of a medical examination instrument and therefore preventing a patient from feeling uncomfortable to the cold contact member.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is an exploded view of the present invention;

FIG. 3 illustrates another preferred embodiment of the present invention;

FIG. 4 illustrates how the first preferred embodiment of the present invention is mounted on a stethoscope; and

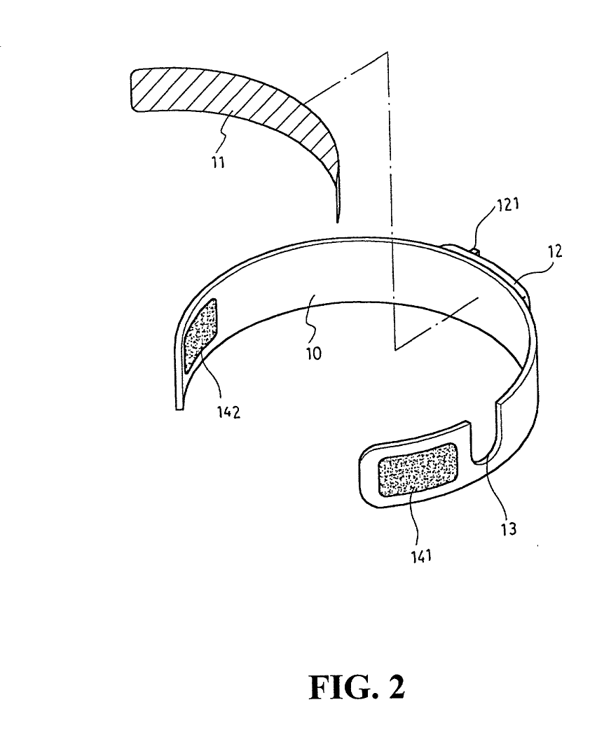

FIG. 2 illusrtrates how the second preferred embodiment of the present invention is mounted on a stethoscope.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

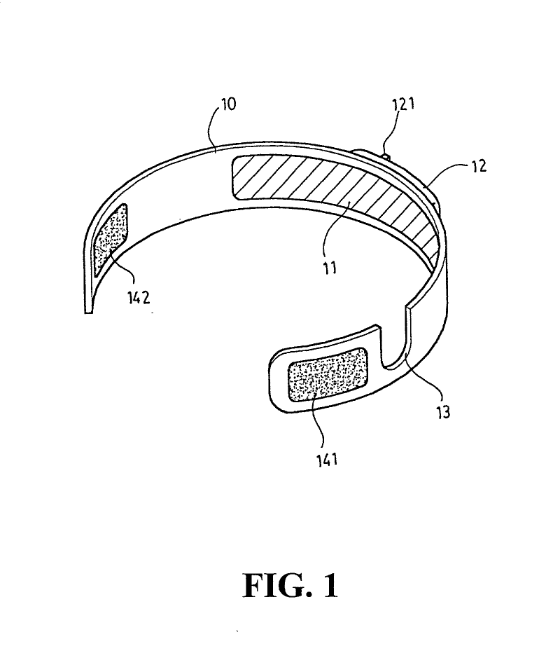

With reference to the drawings and in particular to FIGS. 1 and 2 thereof, the heating sleeve according to the present invention generally comprises an open circular band 10, a flexible heating emitting member 11 affixed to the inner side of the open circular band 10, a power source 12 mounted on the outer side of the open circular band 10, a switch 121 arranged on the power source 12 and electrically connected with the power source 12 and the flexible heat emitting member 11, a first self-adhesive patch 141 affixed to the outer side of a free end of the open circular band 10, and a second self-adhesive patch 142 affixed to the inner side of another free end of the open circular band 10. The flexible heating emitting member 11 may be replaced with a carbon film heat emitting plate. The power source 12 preferably contains batteries. The open circular band 10 is formed with a notch 13 close to the first self-adhesive patch 141. The switch 12 is used for controlling the electric power supplied to the flexible heat emitting member 11 from the power source 12.

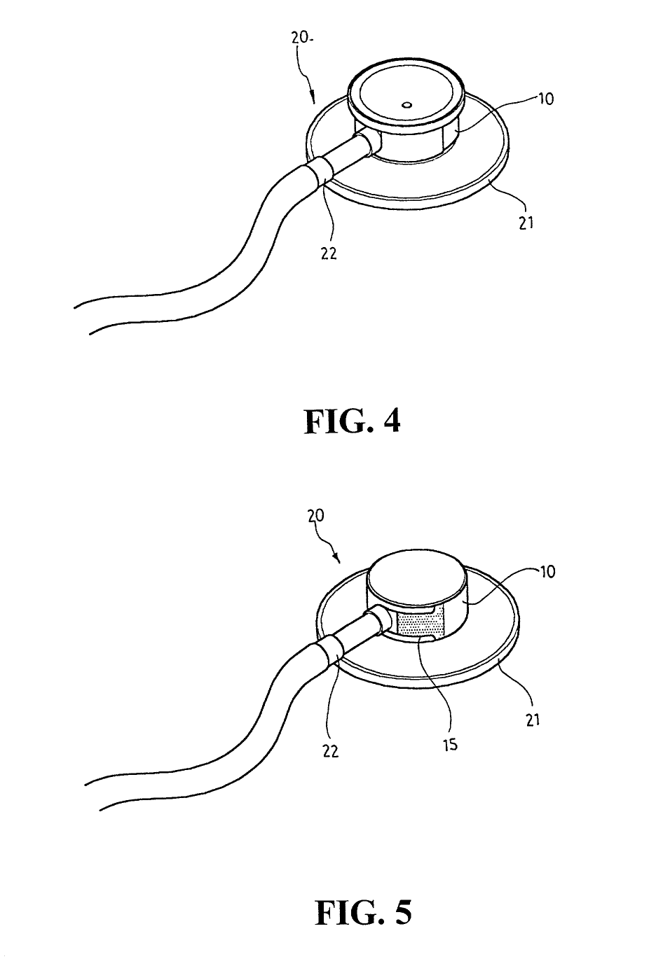

Referring to FIGS. 1 and 4, when in use with a stethoscope 20, the open circular band 10 is first fitted over the neck of the sound receiver 21 of the stethoscope 10 with the notch 13 receiving the connector 22, and then the self-adhesive patches 141 and 142 are engaged together to close the open circular band 10. When the switch 12 is turned on, the flexible heat emitting member 11 will be immediately heated thereby rapidly warming the sound receiver 21 of the stethoscope 20 and therefore preventing the patient from feeling cold and uncomfortable to the cold sound receiver 21. The self-adhesive patches 141 and 142 may be replaced with buckles, fasteners or hooks.

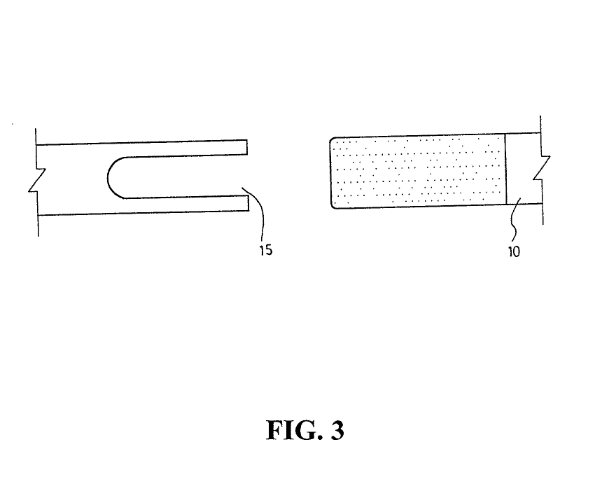

FIGS. 3 and 5 illustrate a second preferred embodiment of the present invention. As shown, the open circular band 10 is formed with a forked end 15 instead of a notch 13, so that when the open circular band 10 is mounted on the sound receiver 21 of the stethoscope 20, the connector 22 between the sound receiver 21 and the flexible tube of the stethoscope 20 will be received in the forked end 15 thereby achieving the same purpose as the notch 13.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A heating sleeve for medical examination instruments comprising:
an open circular band having a free end provided with a first engaging means and another free end provided with a second engaging means engageable with said first engaging means;
a flexible heat emitting member affixed to an inner side of said open circular band;
a power source mounted on an outer side of said open circular band;
whereby said power source will heat said flexible heat emitting member thereby rapidly warning a contact member of a medical examination instrument and therefore preventing a patient from feeling uncomfortable to said cold contact member.

2. The heating sleeve for medical examination instruments as claimed in claim 1, wherein said power source contains batteries and is provided with a switch electrically connected said flexible heat emitting member.

3. The heating sleeve for medical examination instruments as claimed in claim 1, wherein said flexible heat emitting member is a carbon film heat emitting plate.

4. The heating sleeve for medical examination instruments as claimed in claim 1, wherein said open circular band is formed with a notch.

5. The heating sleeve for medical examination instruments as claimed in claim 1, wherein a first self-adhesive patch is affixed to an outer side of a free end of said open circular band, and a second self-adhesive patch is affixed to an inner side of another free end of said open circular band.

6. The heating sleeve for medical examination instruments as claimed in claim 1, wherein said open circular band is formed with a forked end.

7. The heating sleeve for medical examination instruments as claimed in claim 1, wherein said engaging means is replaceable with buckles, fasteners or hooks.
